(19) United States
(12) Patent Application Publication
(10) Pub. No.: US 2003/0080523 A1
(43) Pub. Date: May 1, 2003

(54) Utility push cart

(76) Inventor: Carlos Crespo-Ortiz, San Lorenzo, PR (US)

Correspondence Address: Patent Law Offices of Heath W. Hoglund, 256 Eleanor Roosevelt, San Juan, PR, 00918, US

(21) Appl. No.: 09/999,586

(22) Filed: Oct. 31, 2001

(51) Int. Cl. B62B 3/00

(52) U.S. Cl. 280/47.34

(57) ABSTRACT

A preferred utility cart includes an elongated base and push handles on either end. The elongated base is supported at its center by a carriage having a pair of wheels. It is supported at each of its ends by a carriage having a pair of casters. Preferred methods of constructing the carriages are described.

### FIELD OF THE INVENTION

The invention relates generally to push carts and more particularly to industrial grade carts commonly used in warehouses and industrial stores.

### BACKGROUND OF THE INVENTION

Utility carts are used in a wide variety of commercial and industrial applications, including home improvement stores, garden stores, appliance stores and others. Utility carts that are used in these applications are often subjected to use that includes heavy loads, uneven surfaces and almost constant use. A wide variety of utility carts are shown in the prior art.

Among these, U.S. Pat. No. 6,213,483 teaches a utility cart design that avoids the use of welding in its construction. Although this may reduce the cost of construction, it necessarily decreases the overall strength of the cart. The particular design teaches improvements over earlier designs. Nonetheless, this type of construction typically cannot withstand the constant and heavy use experienced in a commercial application such as a home improvement store.

U.S. Pat. No. 6,260,863 teaches a utility cart especially designed for carrying lumber. One of its unique features is its ability to nest within another cart of the same design. This reduces the storage space required for such a cart. Unfortunately, however, the particular design requires a labyrinth of pipes and the associated construction would make this utility cart inordinately expensive for most applications.

U.S. Pat. No. 6,206,385 teaches a utility cart having a modular flat bed constructed of a metal frame and a plastic flatbed cover. Although it provides relatively simple features including the flat bed and associated support handles, it is relatively complex to construct. This results from the multi-component, multi-material construction. Accordingly, its design would make this utility cart too expensive for many applications.

U.S. Pat. No. 5,531,295 teaches yet another utility cart. One of its unique features is the particular breaking mechanism that can help to prevent a run-away cart. Although the cart itself is made of relatively simple construction, the direct mounting of wheel supports to its flat bed increases the risk that a heavy load will deform the flat bed surface.

In view of the limitations found in the prior art, it would be desirable to obtain a utility cart of simple and inexpensive manufacture. At the same time, it would be desirable that the utility cart could withstand heavy loads in a commercial setting of almost constant use.

### SUMMARY OF THE INVENTION

According to one aspect of the invention a utility cart includes an elongated base, a center carriage, a pair of end carriages and a handle. The elongated base is formed of a single sheet of rectangular metal having a longer length and a narrower width. The single sheet has four bends each of which extend along the length of the elongated base. Each of the bends lie parallel to the other bends. These bends form a top surface, a pair of side walls and a pair of bottom blades in the elongated base. The center carriage is approximately centered along the length of the elongated base. The center carriage includes two parallel angle bars, two pairs of parallel wheel plates and a pair of wheels. The two parallel angle bars are each formed of a horizontal leg and a vertical leg that meet at approximately a right angle. The two parallel angle bars define an interior channel bounded on top by the horizontal legs and bounded on the sides by the vertical legs of the angle bars. The two pairs of parallel wheel plates are positioned at opposite ends within the interior channel. The upper end of each parallel wheel plate meets the horizontal legs of the angle bars and is welded thereto. The outermost wheel plate of each pair meets an inner edge of the bottom blades of the elongated base and is welded thereto. The two parallel angle bars are welded to the center carriage proximate each of the two pairs of parallel wheel plates. The pair of wheels are each positioned between one of the two pairs of parallel wheel plates. An axle passes through the parallel wheel plates and the wheel to form a rotatable connection. The pair of end carriages are positioned at opposite ends of the elongated base. Each of the end carriages includes an end plate, a bottom plate, a pair of side plates, a pair of outer support brackets, a pair of inner support brackets, and a pair of casters. The end plate extends across the width of the elongated base and is welded to the top surface, the pair of side walls and the pair of bottom blades of the elongated base. The bottom plate extends across the width of the end plate. The bottom plate has an outer end and an inner end. The outer end is welded to the end plate so that the bottom plate forms a right angle with the end plate and so that the bottom plate lies parallel to the top surface of the elongated base. The pair of side plates are each positioned substantially in the same plane as one of the side walls of the elongated base. Each of the side plates extend from proximate the outer end to proximate the inner end of the bottom plate and connect between the bottom plate and one of the side walls of the elongated base. Each of the side plates are welded to the end plate along a right-angle joint formed therewith, and to the bottom plate along a right-angle joint formed therewith, and to one of the side walls of the elongated base. The pair of outer support brackets each extend from the bottom plate up to one of the bottom blades of the elongated base. Each of the outer support brackets are welded to one of the bottom blades of the elongated base at a right-angle joint formed therewith, and to one of the side plates along a right-angle joint formed therewith, and to the bottom plate. The pair of inner support brackets each extend from the bottom plate up to the top surface of the elongated base. The par of inner support brackets are positioned parallel to the side walls of the elongated base. Each of the inner support brackets are welded to the bottom plate at a right-angle joint formed therewith and to the top surface of the elongated base at a right-angle joint formed therewith. The pair of casters is attached with the bottom plate within mounting areas bounded by the end plate, the side plates, the outer support brackets and the inner support brackets. The handle is connected with the end plate of one of the end carriages. The connection is made proximate the side plates.

According to a further aspect of the invention, the end plate, the side plates and the outer support brackets and the inner support brackets of the end carriages each rest upon the bottom plate of the end carriage.

According to a further aspect of the invention, the handle connects to the end carriage though a handle bracket. The handle bracket is vertically welded on an outer surface of the end plate of the end carriage. The top surface and bottom blades of the elongated base are horizontally welded to an inner surface of the end plate of the end carriage. Each of these horizontal welds cross the vertical weld between the handle bracket and the end plate.

Still further aspects of the invention will become apparent upon further review of the drawings and the detailed description that follows.

### BRIEF DESCRIPTION OF THE DRAWINGS

FIG. 1 is a perspective view of one preferred utility cart including a base 102, a center carriage 104 and a pair of end carriages 106.

FIG. 2A is a top perspective view of the base 102 of FIG. 1 shown apart from the utility cart of FIG. 1.

FIG. 2B is a bottom perspective view of the base 102 of FIG. 1 shown apart from the utility cart of FIG. 1.

FIG. 3A is a side plan view of the center carriage 104 of FIG. 1 shown apart from the utility cart of FIG. 1 and without associated wheels.

FIG. 3B is another side plan view of the center carriage 104 of FIG. 1 also shown apart from the utility cart of FIG. 1 and without associated wheels.

FIG. 3C is a bottom plan view of the center carriage 104 of FIG. 1 also shown apart from the utility cart of FIG. 1 and without associated wheels.

FIG. 3D is a bottom perspective view of the center carriage 104 also shown apart from the utility cart of FIG. 1 and without associated wheels.

FIG. 3E is a bottom perspective view of the center carriage 104 of FIG. 1 also shown apart from the utility cart of FIG. 1.

FIG. 4A is a top plan view of the end carriage of FIG. 1 shown apart from the utility cart of FIG. 1.

FIG. 4B is a front plan view of the end carriage of FIG. 1 also shown apart from the utility cart of FIG. 1.

FIG. 4C is a side plan view of the end carriage of FIG. 1 also shown apart from the utility cart of FIG. 1.

FIG. 4D is a bottom perspective view of the end carriage of FIG. 1 also shown apart from the utility cart of FIG. 1 and without associated casters.

### DETAILED DESCRIPTION

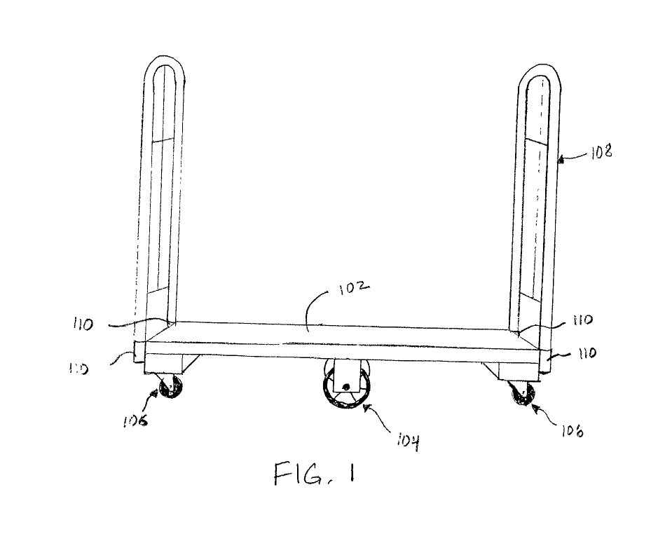

FIG. 1 illustrates one preferred embodiment of a push cart. In broad terms it includes a base 102, a center carriage 104, a pair of end carriages 106, and push handles 108. The center carriage 104 extends further below base 102 than either of the end carriages 106. Consequently, the push cart teeters upon the center carriage 104 and one of the end carriages 106.

The center carriage 104 includes a pair of wheels and each of the end carriages includes a pair of casters. In use, a heavy load may be placed upon the base 102 preferably at or near its center so that the center carriage 104 provides most of the support for the load. An operator may push (or pull) on either of the handles 108. This causes the push cart to move upon the carriages 104 and 106. When the operator wishes to turn the push cart, the operator simply pushes sideways upon one of the handles 108. The center carriage 104 acts as a fulcrum and the end carriage 106 upon which the push cart rests moves along an arc about that fulcrum.

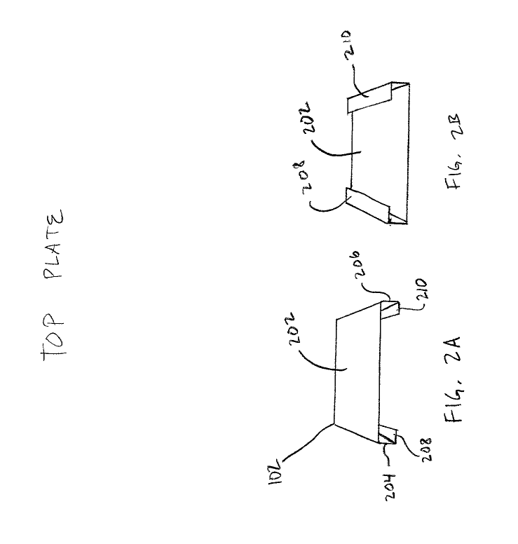

Turning to FIGS. 2A-2B, the base 102 will be described in further detail. The base 102 is formed of a single sheet of metal. The base 102 includes a top surface 202, a left wall 204, a right wall 206, a left bottom blade 208 and a right bottom blade 210. These individual parts are formed by bending the single sheet of metal. It begins with a rectangular shape. Along its longer side a bend is made between the top surface 202 and left wall 204. This bend runs parallel to the longer side of the rectangle and extends along its entire length. Another bend is made between the left side wall 204 and the left bottom blade 208. Preferably, each of these bends are formed at right angles. This bend runs parallel to the previous bend. The right side wall 206 and the right bottom blade 208 are constructed in the same manner so that the base 102 is symmetric about a plane extending lengthwise along its center.

A majority of the single sheet of metal is used to form the top surface 202. The remainder is used to form the left side wall 204, the right side wall 206, the left bottom blade 208 and the right bottom blade 210. Consequently, these parts are substantially narrower than the top surface 202. The left bottom blade 208 and the right bottom blade 210 lie parallel to the top surface 202, but each extend across only a small fraction of the top surface 202. Left side wall 204 and right side wall 206 lie in parallel planes.

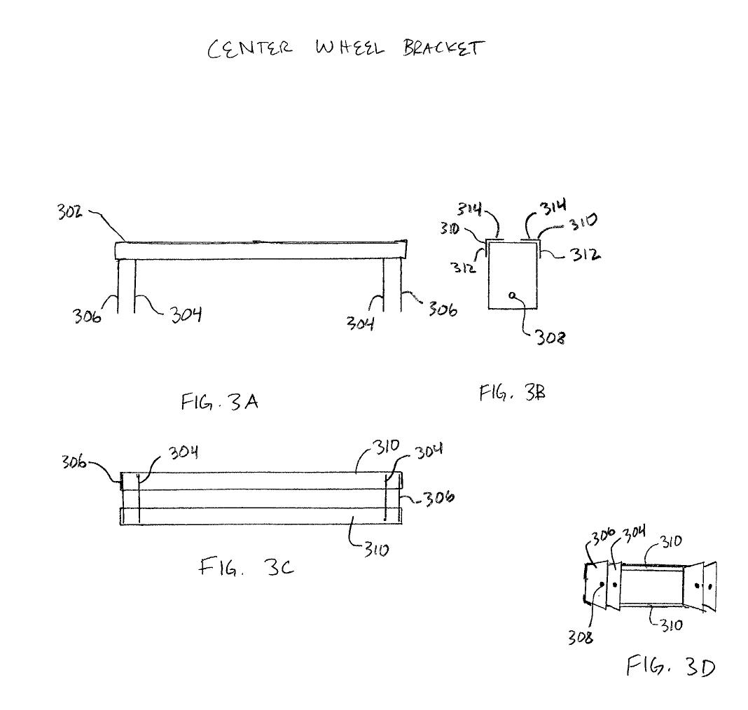

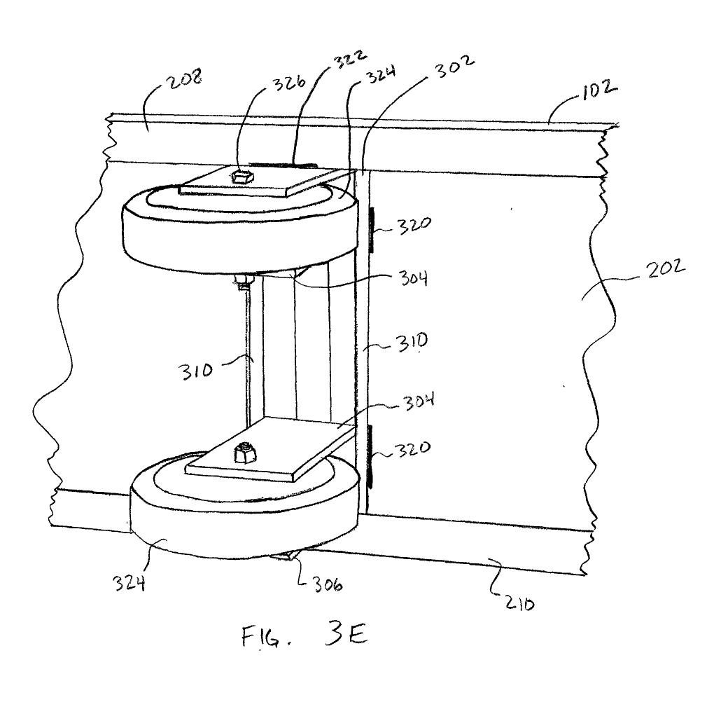

Turning to FIGS. 3A-3D, one preferred embodiment of a center wheel bracket 302 is described. It is used as part of the center carriage 104. It reinforces base 102 as it joins with the center supporting wheels. At each end the center wheel bracket 302 includes an inner plate 304 and a parallel outer plate 306. The inner plate 304 and the outer plate 306 are spaced sufficiently to house a support wheel (not shown). These support wheels are used to bear most of the load in use of the push cart. Accordingly, they are of rugged construction. Inner plate 304 and outer plate 306, each define a hole proximate their bottom end. These holes are used to pass a mounting bolt that serves as the axle for the support wheel. Since this will be used to support the load on the push cart, the inner plate 304 and outer plate 306 are of heavy construction.

Center wheel bracket 302 also includes a pair of parallel angle beams 310. Each has an “L” shape, with side legs 312 and top legs 314 of equal length. The side legs 312 meet the connected top leg 314 at a right angle. The angle beams 310 are positioned across the top of inner plates 304 and outer plates 306. In particular, top legs 314 rest upon the top of inner plates 304 and outer plates 306. Side legs 312 connect along the side of inner plates 304 and outer plates 306. Together the angle beams 310 form an interior channel around the top portion of inner plates 304 and outer plates 306.

This particular configuration provides easy construction. Specifically, the angle beams 310 may be placed on the ground or other construction surface. The top legs 314 rest flat against the surface and side legs 312 extend upward at a right angle from the construction surface. The angle beams 310 lie parallel and are spaced so that their inner plates 304 and outer plates 306 may be placed at right angles with respect to the angle beams 310. Resting against top legs 314, they are welded in place so that side legs 312 press against the sides of the inner plates 304 and outer plates 306. The welds extend along both the top legs 314 and the side legs 312 to form a rigid bond between the pieces.

After constructing the center wheel bracket 302, it is attached to base 102. For ease of construction, it is attached along with end carriage 106, which is further described below. Specifically, base 102 is turned up-side down (as shown in FIG. 2B) so that the left wall 204 and right wall 206 extend upward from top surface 202. The center wheel bracket 302 is placed between the left bottom blade 208 and the right bottom blade 210. The angle beams 310 lie perpendicular to the left bottom blade 208 and to the right bottom blade 210. The outer surfaces of outer plates 306 lies parallel to the inner edge of the left bottom blade 208 and the right bottom blade 210. On each side, one of the outer brackets 306 meet the inner edges of the left bottom blade 208 and the right bottom blade 210.

To hold the center wheel bracket in place, the angle beams 310 are welded to the bottom side of top surface 202. Preferably, these welds are made in four places so that each such weld is made adjacent to the inner bracket 304 and outer bracket 306. Two of these welds are shown in FIG. 3E as welds 320. The other two are made along the other angle bracket 310, but are not visible from the perspective illustrated. Nonetheless, they are made in substantially the same position along the other angle bracket 310.

Two additional welds are made along the joint formed by left bottom blade 208 and one of the outer brackets 306, and the joint formed by right bottom bracket 210 and the other outer bracket 306.

After these welds have been made, the center wheels are mounted in the center wheel bracket 302. The inner bracket 304 and outer bracket 306 are spaced to to fit center wheels 324. Bolts 326 are passed through holes 308 and serve as an axle for the center wheels 324.

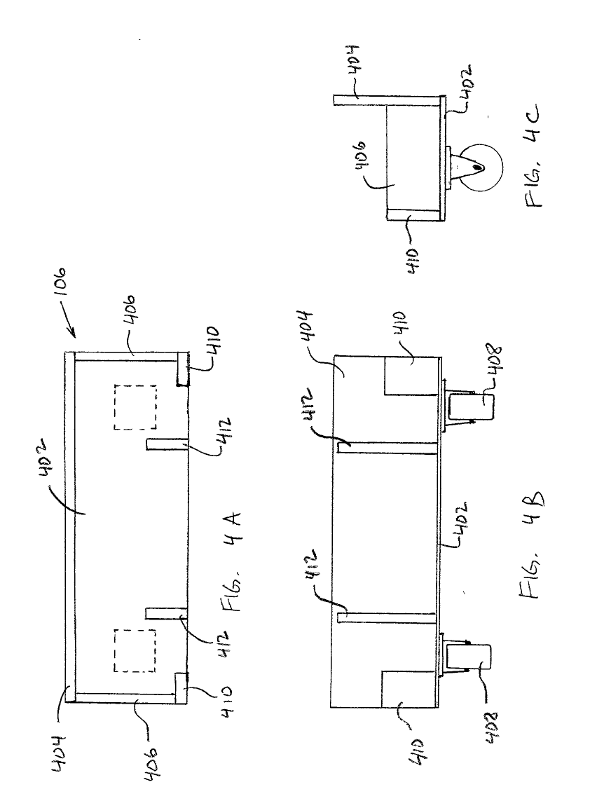

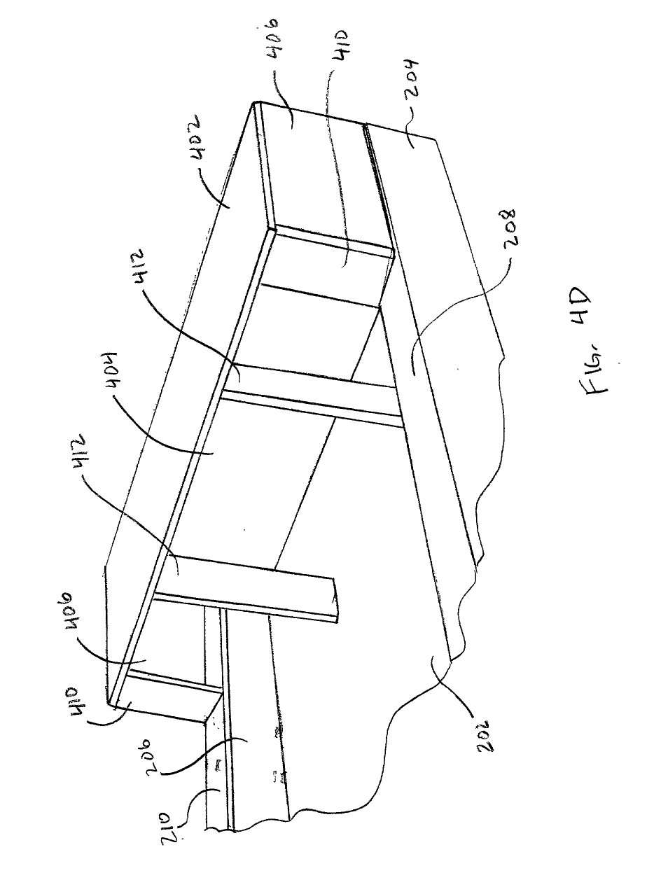

Turning to FIGS. 4A-4C, one preferred end carriage 106 is described. It is used to reinforce the base 102 as it joins with casters 408. End carriage 106 spreads the load, and related stresses and strains, with support casters 408 about the end of base 102. This configurations greatly increase the longevity of the push cart. End carriage 106 includes a bottom plate 402, an end plate 404 and a pair of side plates 406. The bottom plate 402 is rectangular. Its longer side has approximately the same dimension as the width of base 102. Likewise, end plate 404 is rectangular. Its longer side has approximately the same dimension as the width of base 102. The end plate 404 joins with bottom plate 402 at a right angle. End plate 404 and bottom plate are welded together along this joint.

Side plates 406 also rest upon bottom plate 402. These are rectangular and form right-angle joints with bottom plate 402 and with end plate 404. These joints are welded together. Side plates 406 extend only partially up end plate 404 (shown most clearly in FIG. 4C). When base 102 is placed upon end carriage 106, the corner between side walls 204 and 206 and bottom blades 208 and 210 (shown in FIGS. 2A-2B), respectively, rest upon side plates 406. End plate 404 extends to the top surface 202 (also shown in FIGS. 2A-2B) of base 102.

End carriage 106 also includes a pair of outer support brackets 410 and inner support brackets 412. Outer support brackets 410 form right-angle joints with side plates 406 and with bottom plate 402. These joints are welded. Outer support brackets 410 extend to the same height as the side plates 406. When base 102 is placed upon end carriage 106, the bottom blades 208 and 210 rest upon the outer support brackets 410. Inner support brackets 412 extend higher than outer support brackets 410. In particular, these extend to meet the bottom of top surface 202. Accordingly, they extend just below the height of end plate 404, which extends to the top of top surface 202.

From the top view shown in FIG. 4A, a pair of reinforced mounting areas are formed to support the load borne by casters 408. The dashed lines illustrate the profile of the caster mounting surface. Each reinforce mounting area is bounded by end plate 404, side plate 406, outer support bracket 410 and inner support bracket 412. These define a quadrilateral that is approximately square at each end of the bottom plate 402 for mounting the casters 408.

For ease of construction, the end carriage is assembled by placing the bottom plate 402 upon the ground or other construction surface. The end plate 404 is first positioned upon bottom plate 402 and welded in place along their joint. Side plates 406 are positioned upon bottom plate 402 and against end plate 404. Side plates 406 are welded along their joints with the bottom plate 402 and end plate 404. Next, outer support brackets 410 are positioned upon bottom plate 402 and against side plates 406. The outer support brackets are welded along their joints with the bottom plate 402 and side plates 406.

The inner support brackets 412 can be attached next or after the rest of the end carriage has been attached to the base 102. Inner support brackets 412 are welded to the bottom plate 402 along their bottom end; they are welded to the bottom of top surface 202 along their top end.

Likewise, the casters 408 are preferably welded to the bottom of bottom plate 402. They may attached before or after attaching the rest of the end carriage 106 to base 102. In either case, they are positioned within the approximately square mounting area defined by the back plate 404, the side plate 406, the outer support bracket 410 and the inner support bracket 412. This operates to distribute the load from the base 102 to the caster 408.

Finally, handle brackets 110 (shown in FIG. 1) are welded to the outside surface of end plate 404. Preferably, the handle brackets 110 are simply a short section of pipe. Handles 108 are also constructed of pipe having a smaller diameter so that the ends fit within the handle brackets 110. A constriction at or near the bottom of handle brackets 110 prevents handles 108 from sliding completely through handle brackets 108. The handle brackets 108 are positioned as near to the ends of end plate 404 as possible without broadening the profile of the cart. In other words, they are approximately flush with side wall 204 and side wall 206.

To attach the end carriage 106 to the base 102, the base is preferably turned up-side down (as shown in FIG. 2B). The end carriage 106 is also turned upside down and placed on top of base 102 (as shown in FIG. 4D). Again, the casters 408 may be attached before or after mounting the end carriage 106 to base 102. After positioning the end carriage 106, welds are made along the joints formed between (1) left bottom blade 208 and the associated outer support bracket 410; (2) right bottom blade 210 and the other outer support bracket 410; (3) the left side wall 204 and the associated side plate 406; (4) the right side wall 206 and the other side plate 406; (5) the left side wall 204 and the end plate 404; (6) the right side wall 206 and the end plate 404; and (7) the top surface 202 and end plate 404. In addition, the top end of the inner support brackets 412 (shown at the bottom in FIG. 4D) are welded to the top surface 202. The end of left bottom blade 208 that abuts end plate 404 and forms a joint. This is also welded. Likewise the joint formed between the end of right bottom blade 210 and end plate 404 is welded. This secures end carriage 106 to the base 102 and creates a rigid bond for distributing the load to the end carriage 106 from the base 102.

Since the force from an operator pushing the cart will be transmitted from handles 108 to base 102 at this junction, strength is a critical factor in its design. Indeed, this is a source of failure for many commercial push carts. By positioning the handle brackets 110 as near to the outer ends of end plate 404 as possible, the force is absorbed through the joints and connections made with bottom plate 402, side plate 406, side walls 204 and 206, bottom blades 208 and 210, and top surface 202. Preferably the weld(s) between handle bracket 110 and end plate 404 cross on the outside of the welds made on the inside for the just mentioned joints and connections, particularly bottom blades 208 and 210, and top surface 202. This operates to give great strength and longevity to this connection.

Although the invention has been described with reference to a preferred embodiment, those skilled in the art will certainly appreciate that many variations, modification, additions and deletions may be made without departing from the spirit of the invention. Al such variation, modifications, additions and deletions are intended to be encompassed within the scope of the following claims.

I claim:

1. A utility cart comprising:
an elongated base formed of a single sheet of rectangular metal having a longer length and a narrower width and having only four bends each of which extend along the length of the elongated base and each of which are parallel to the other bends so that the elongated base includes a top surface, a pair of side walls and a pair of bottom blades;
a center carriage approximately centered along the length of the elongated base and including:
two parallel angle bars each of which is formed of a horizontal leg and a vertical leg that meet at approximately a right angle and are configured to define an interior channel bounded on top by the horizontal legs and bounded on the sides by the vertical legs of the angle bars,
two pairs of parallel wheel plates positioned at opposite ends within the interior channel so that an upper end of each parallel wheel plate meets the horizontal legs of the angle bars and is welded thereto, and wherein an outermost wheel plate of each pair meets an inner edge of the bottom blades of the elongated base and is welded thereto, and wherein the two parallel angle bars are welded to the center carriage proximate each of the two pairs of parallel wheel plates,
a pair of wheels each one positioned between one of the two pairs of parallel wheel plates and rotatably connected by an axle that passes through the parallel wheel plates and the wheel,
a pair of end carriages positioned at opposite ends of the elongated base, wherein each of the end carriages includes:
an end plate that extends across the width of the elongated base and is welded to the top surface, the pair of side walls and the pair of bottom blades of the elongated base,
a bottom plate that extends across the width of the end plate and has an outer end and an inner end, the outer end of which is welded to the end plate so that the bottom plate forms a right angle with the end plate and so that the bottom plate lies parallel to the top surface of the elongated base,
a pair of side plates each positioned substantially in the same plane as one of the side walls of the elongated base, wherein each of the side plates extend from proximate the outer end to proximate the inner end of the bottom plate and connect between the bottom plate and one of the side walls of the elongated base, and wherein each of the side plates are welded to the end plate along a right-angle joint formed therewith, the bottom plate along a right-angle joint formed therewith and one of the side walls of the elongated base,
a pair of outer support brackets each of which extend from the bottom plate up to one of the bottom blades of the elongated base, wherein each of the outer support brackets are welded to one of the bottom blades of the elongated base at a right-angle joint formed therewith, one of the side plates along a right-angle joint formed therewith, and the bottom plate,
a pair of inner support brackets each of which extend from the bottom plate up to the top surface of the elongated base and are positioned parallel to the side walls of the elongated base, wherein each of the inner support brackets are welded to the bottom plate at a right-angle joint formed therewith and to the top surface of the elongated base at a right-angle joint formed therewith, and
a pair of casters attached with the bottom plate within mounting areas bounded by the end plate, the side plates, the outer support brackets and the inner support brackets; and
at least one handle connected with the end plate of one of the end carriages, wherein the connection is made proximate the side plates.

2. The utility cart of claim 1, wherein the end plate, the side plates and the outer support brackets and the inner support brackets of the end carriages each rest upon the bottom plate of the end carriage.

3. The utility cart of claim 1, wherein the at least one handle connects to the end carriage though a handle bracket, wherein the handle bracket is vertically welded on an outer surface of the end plate of the end carriage, and wherein the top surface and bottom blades of the elongated base are horizontally welded to an inner surface of the end plate of the end carriage so that each of these horizontal welds cross the vertical weld between the handle bracket and the end plate.

4. A utility cart especially suitable for heavy commercial applications comprising:
an elongated base formed of a single sheet of rectangular metal having a longer length and a narrower width and having at least four bends each of which extend along the length of the elongated base and each of which are parallel to the other bends so that the elongated base includes a top surface, a pair of side walls and a pair of bottom blades;
a center carriage approximately centered along the length of the elongated base and including:
two parallel angle bars each of which is formed of a horizontal leg and a vertical leg that meet at approximately a right angle and are configured to define an interior channel bounded on top by the horizontal legs and bounded on the sides by the vertical legs of the angle bars,
two pairs of parallel wheel plates positioned at opposite ends within the interior channel so that an upper end of each parallel wheel plate meets the horizontal legs of the angle bars and is welded thereto, and wherein an outermost wheel plate of each pair meets an inner edge of the bottom blades of the elongated base and is welded thereto, and wherein the two parallel angle bars are welded to the center carriage proximate each of the two pairs of parallel wheel plates,
a pair of wheels each one positioned between one of the two pairs of parallel wheel plates and rotatably connected by an axle that passes through the parallel wheel plates and the wheel,
a pair of end carriages positioned at opposite ends of the elongated base, wherein each of the end carriages includes:
an end plate that extends across the width of the elongated base and is welded to the top surface, the pair of side walls and the pair of bottom blades of the elongated base,
a bottom plate that extends across the width of the end plate and has an outer end and an inner end, the outer end of which is welded to the end plate so that the bottom plate forms a right angle with the end plate and so that the bottom plate lies parallel to the top surface of the elongated base,
a pair of side plates resting upon the bottom plate each positioned substantially in the same plane as one of the side walls of the elongated base, wherein each of the side plates extend from proximate the outer end to proximate the inner end of the bottom plate and connect between the bottom plate and one of the side walls of the elongated base, and wherein each of the side plates are welded to the end plate along a right-angle joint formed therewith, the bottom plate along a right-angle joint formed therewith and one of the side walls of the elongated base,
a pair of outer support brackets resting upon the bottom plate each of which extend from the bottom plate up to one of the bottom blades of the elongated base, wherein each of the outer support brackets are welded to one of the bottom blades of the elongated base at a right-angle joint formed therewith, one of the side plates along a right-angle joint formed therewith, and the bottom plate,
a pair of inner support brackets resting upon the bottom plate each of which extend from the bottom plate up to the top surface of the elongated base and are positioned parallel to the side walls of the elongated base, wherein each of the inner support brackets are welded to the bottom plate at a right-angle joint formed therewith and to the top surface of the elongated base at a right-angle joint formed therewith, and
a pair of casters attached with the bottom plate within mounting areas bounded by the end plate, the side plates, the outer support brackets and the inner support brackets; and
at least one handle connected with the end plate of one of the end carriages, wherein the connection is made proximate the side plates, wherein the at least one handle connects to the end carriage though a handle bracket, wherein the handle bracket is vertically welded on an outer surface of the end plate of the end carriage, and wherein the top surface and bottom blades of the elongated base are horizontally welded to an inner surface of the end plate of the end carriage so that each of these horizontal welds cross the vertical weld between the handle bracket and the end plate.

5. The utility cart of claim 4, wherein the center carriage extends further below the elongated base than either of the end carriages so that the utility cart teeters upon the center carriage.
